(19) United States
(12) Patent Application Publication
(10) Pub. No.: US 2016/0248158 A1
(43) Pub. Date: Aug. 25, 2016

(54) MULTI-BAND ANTENNA

(71) Applicant: KMW Inc., Hwaseong (KR)

(72) Inventors: Sung-Hwan So, Hwaseong (KR); Hun-Jung Jung, Hwaseong (KR)

(73) Assignee: KMW Inc.

(21) Appl. No.: 15/147,019

(22) Filed: May 5, 2016

Related U.S. Application Data
(63) Continuation of application No. PCT/KR2014/009829, filed on Oct. 20, 2014.

(30) Foreign Application Priority Data
Nov. 8, 2013 (KR) 10-2013-0135481

(51) Int. Cl. H01Q 3/34; H01Q 21/28

(52) U.S. Cl. CPC H01Q 3/34; H01Q 21/28

(57) ABSTRACT

The present invention relates to a multi-band antenna, which comprises: a first antenna array of a first band configured by a radiation module of the first band; a (2-1)th antenna array of a common band between a second band and third band, the (2-1)th antenna array including radiation modules for the common band between the second band and third band; a (2-1)th phase shifter for receiving an input signal of the second band, distributing signals having phase difference therebetween to pre-configured radiation modules or groups of multiple radiation modules among the radiation modules of the (2-1)th antenna array, respectively, and then providing the signals; a (3-1)th phase shifter for receiving an input signal of the second band, distributing signals having phase difference therebetween to pre-configured radiation modules or groups of multiple radiation modules among the radiation modules of (2-1)th antenna array, respectively, and then providing the signals; a plurality of (2-1)th frequency combiners for combining one pre-configured signal among output signals of the (2-1)th phase shifter with one corresponding signal among output signals of the (3-1)th phase shifter, and providing a combined signal to each pre-configured radiation module among the radiation modules of the (2-1)th antenna array or a pre-configured group among groups of multiple radiation modules among the radiation modules of the (2-1)th antenna array.

### CROSS REFERENCE TO RELATED APPLICATIONS

This application is a continuation of International Application No. PCT/KR2014/009829 filed on Oct. 20, 2014, which claims priority to Korean Application No. 10-2013-0135481 filed on Nov. 8, 2013, which applications are incorporated herein by reference.

### TECHNICAL FIELD

The present disclosure relates to an antenna technology suitable for a mobile communication (personal communication service (PCS), cellular, international mobile telecommunication-2000 (IMT-2000) or the like) base station or relay, and more particularly, to a multi-band antenna.

### BACKGROUND ART

Along with the popularity of mobile communications and wireless broadband data communication, efforts are now made to render various frequency bands to be available due to the lack of frequency bands. Multiple input and multiple output (MIMO) based on multiple antennas is a requisite technology to increase data rate, finding its applications in mobile communication network systems such as long term evolution (LTE) and mobile worldwide interoperability for microwave access (Mobile WiMAX).

FIG. 1 illustrates an exemplary structure of a general multi-band antenna. For example, the multi-band antenna is a triple-band antenna. Referring to FIG. 1, the multi-band antenna may include, for example, a first antenna array 9 of a first band, (2-1)^{th} and (2-2)^{th} antenna arrays 11 and 12 of a second band, and (3-1)^{th} and (3-2)^{th} antenna arrays 31 and 32 of a third band, which are arranged, for example, on a single reflective plate (not shown) standing upright in a lengthwise direction. The first band may be an 800-MHz (for example, 808-MHz to 860-MHz) cellular band, the second band may be a 2.5-GHz (for example, 2.495-GHz to 2.690-GHz) broadband radio service (BRS) band, and the third band may be a 1.9-GHz (for example, 1.850-GHz to 1.995-GHz) US-PCS band.

The first antenna array 9 may be arranged at the center of the reflective plate, the (2-1)^{th} and (3-1)^{th} antenna arrays 11 and 31 may be arranged on the right side of the first antenna array 9, and the (2-2)^{th} and (3-2)^{th} antenna arrays 12 and 32 may be arranged on the left side of the first antenna array 9. It may be understood that the (2-1)^{th} and (2-2)^{th} antenna arrays 11 and 12, and the (3-1)^{th and (}3-2)^{th} antenna arrays 31 and 32 are installed in a double structure to implement a MIMO antenna of the second band and a MIMO antenna of the third band, respectively in the above-described structure.

The first antenna array 9 is configured generally to include a plurality of radiation modules for the first band arranged vertically in a row. Similarly, each of the (2-1)^{th} and (2-2)^{th} antenna arrays 11 and 12 is configured generally to include a plurality of radiation modules for the second band arranged vertically in a row, and each of the (3-1)^{th} and (3-2)^{th} antenna arrays 31 and 32 is configured generally to include a plurality of radiation modules for the third band arranged vertically in a row. Each of the radiation modules for the first, second, and third bands is configured generally to include four 4-directional radiation elements arranged at +45 degrees and −45 degrees on the whole with respect to a vertical (or horizontal) direction, so that two mutually orthogonal linear polarizations (that is X polarizations) are generated.

Meanwhile, as radiation elements and radiation modules with broadband characteristics have recently been demanded, radiation elements covering a band with a fractional band width of about 45% are offered. Such a radiation element may have an operation characteristic of, for example, a 1710-MHz to 2690-MHz band. If a multi-band antenna is implemented with such broadband radiation elements, the radiation modules for the second and third bands may be configured with broadband radiation elements all having substantially identical structures.

To provide an electrical vertical tilt to total radiation beams emitted from the first antenna array 9 of the first band, the multi-band antenna illustrated in FIG. 1 includes a first phase shifter 10 for receiving an input signal of the first band, dividing the input signal, and providing the divided signals to the radiation modules of the first antenna array 9 in such a manner that the divided signals provided to the radiation modules arranged vertically in a row may have a predetermined phase difference between them.

To provide an electrical vertical tilt to radiation beams emitted from the (2-1)^{th} antenna array 11, the multi-band antenna further includes a (2-1)^{th} phase shifter 41 for receiving an input signal of the second band, dividing the input signal, and providing the divided signals to the radiation modules of the (2-1)^{th} antenna array 11, so that each radiation module or each group of radiation modules may have a predetermined phase difference. The radiation modules of the (2-1)^{th} antenna array 11 may be grouped, for example, by pair, and each group of radiation modules may be connected to the (2-1)^{th} phase shifter 41 through a (2-1)^{th} power divider 13 for the second band. In this case, it may be noted that a phase difference is generated on a radiation module group basis.

Likewise, the multi-band antenna further includes a (2-2)^{th} phase shifter 42 for receiving an input signal of the second band, dividing the input signal, and providing the divided signals to the radiation modules of the (2-2)^{th} antenna array 12, so that the radiation modules or groups of radiation modules may have a predetermined phase difference between them. Each of a plurality of groups of radiation modules in the (2-2)^{th} antenna array 12 may be connected to the (2-2)^{th} phase shifter 42 through a (2-2)^{th} power divider 14 for the second band.

The multi-band antenna also includes a (3-1)^{th} phase shifter 51 for receiving an input signal of the third band, dividing the input signal, and providing the divided signals to the radiation modules of the (3-1)^{th} antenna array 31, so that the radiation modules or groups of radiation modules may have a predetermined phase difference between them. Each of a plurality of groups of radiation modules in the (3-1)^{th} antenna array 31 may be connected to the (3-1)^{th} phase shifter 51 through a (3-1)^{th} power divider 33 for the third band.

The multi-band antenna further includes a (3-2)^{th} phase shifter 52 for receiving an input signal of the third band, dividing the input signal, and providing the divided signals to the radiation modules of the (3-2)^{th} antenna array 32, so that the radiation modules or groups of radiation modules may have a predetermined phase difference between them. Each of a plurality of groups of radiation modules in the (3-2)^{th} antenna array 32 may be connected to the (3-2)^{th} phase shifter 52 through a (3-2)^{th} power divider 34 for the third band.

The (2-1)^{th} and (2-2)^{th} power dividers 13 and 14 for the second band, and the (3-1)^{th} and (3-2)^{th} power dividers 33 and 34 for the third band may be designed so as to be used substantially commonly for the second and third bands. In this case, all of the (2-1)^{th} and (2-2)^{th} power dividers 13 and 14, and the (3-1)^{th} and (3-2)^{th} power dividers 33 and 34 may be configured in the substantially same structure. While the term, power divider has been used above, it will be understood that if the directions of input and output signals are reserved, such a power divider may have a configuration for serving as a power combiner.

The multi-band antenna may be configured as illustrated in FIG. 1. In the multi-band antenna, for example, the first antenna array 9, the (2-1)^{th} and (2-2)^{th} antenna arrays 11 and 12, and the (3-1)^{th} and (3-2)^{th} antenna arrays 31 and 32 may be installed on the front surface of the reflective plate, whereas the other components related to a feeding network may be installed on the rear surface of the reflective plate.

The multi-band antenna illustrated in FIG. 1 has the (2-1)^{th} and (3-1)^{th} antenna arrays 11 and 31 arranged on the right side of the first antenna array 9, and the (2-2)^{th} and (3-2)^{th} antenna arrays 12 and 32 arranged on the left side of the first antenna array 9. Thus, the overall antenna size of the multi-band antenna, particularly the latitudinal width of the multi-band antenna is very large.

FIG. 2 illustrates another exemplary structure of the general multi-band antenna. As illustrated in FIG. 1, the multi-band antenna includes the first antenna array 9 of the first band, the (2-1)^{th} and (2-2)^{th} antenna arrays 11 and 12 of the second band, and the (3-1)^{th} and (3-2)^{th} antenna arrays 31 and 32 of the third band. Like the structure of FIG. 1, the multi-band antenna illustrated in FIG. 2 includes the first phase shifter 10, the (2-1)^{th} and (2-2)^{th} phase shifters 41 and 42, the (3-1)^{th} and (3-2)^{th} phase shifters 51 and 52, and the (2-1)^{th} and (2-2)^{th} power dividers 13 and 14.

In the multi-band antenna illustrated in FIG. 2, however, the radiation modules of the (2-1)^{th} and (3-1)^{th} antenna arrays 11 and 31 are arranged in a row along the same vertical axis on the right side of the first antenna array 9. Likewise, the radiation modules of the (2-2)^{th} and (3-2)^{th} antenna arrays 12 and 33 are arranged in a row along the same vertical axis on the left side of the first antenna array 9.

Although the multi-band antenna illustrated in FIG. 2 has a relatively small latitudinal width compared to the multi-band antenna illustrated in FIG. 1, the former has a very large longitudinal length.

As illustrated in FIGS. 1 and 2, the conventional multi-band antennas are large in size. As a result, their installation cost increases and constraints are imposed on a tower space in which the antennas are to be installed in a real outdoor environment.

### SUMMARY

Accordingly, an object of the present disclosure is to provide a multi-band antenna which has an optimized structure and decreases an antenna size, for facilitating antenna design and offering more stable characteristics.

In an aspect of the present invention, a multi-band antenna includes a first antenna array of a first band, including radiation modules for the first band, a (2-1)^{th} antenna array of second and third common bands, including radiation modules for the second and third common bands, a (2-1)^{th} phase shifter for receiving an input signal of the second band, dividing the input signal, and providing divided signals having a phase difference to predetermined radiation modules or a plurality of radiation module groups on a radiation module basis or a radiation module group basis among the radiation modules of the (2-1)^{th} antenna array, a (3-1)^{th} phase shifter for receiving an input signal of the third band, dividing the input signal, and providing divided signals having a phase difference to predetermined radiation modules or a plurality of radiation module groups on a radiation module basis or a radiation module group basis among the radiation modules of the (2-1)^{th} antenna array, and a plurality of (2-1)^{th} frequency combiners each for combining a predetermined one of signals output from the (2-1)^{th} phase shifter with one of signals output from the (3-1)^{th} phase shifter corresponding to the (2-1)^{th} frequency combiner, and providing the combined signal to each of predetermined radiation modules or a predetermined one of a plurality of radiation module groups among the radiation modules of the (2-1)^{th} antenna array.

The radiation modules of the (2-1)^{th} antenna array are divided into a group used for the second or third band, a group for the third band, and a group common for the second and third bands, the group for the second or third band is connected to one of the (2-1)^{th} phase shifter and the (3-1)^{th} phase shifter, corresponding to the group for the second or third band, and the group common for the second and third band is connected to the (2-1)^{th} phase shifter and the (3-1)^{th} phase shifter, through the (2-1)^{th} frequency combiners.

### BRIEF DESCRIPTION OF DRAWINGS

FIG. 1 illustrates an exemplary structure of a general multi-band antenna.

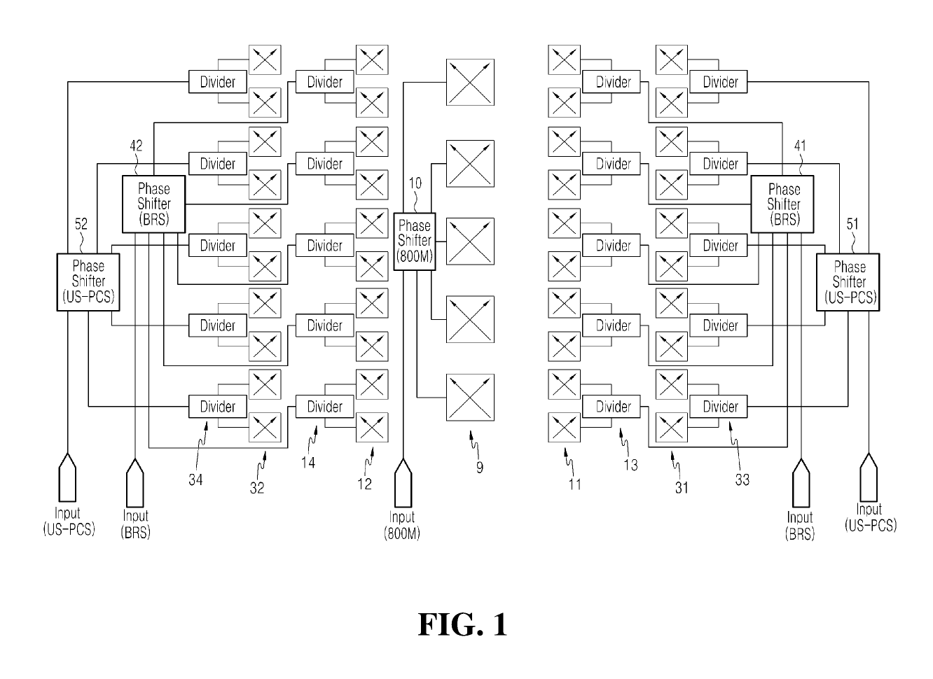

FIG. 2 illustrates another exemplary structure of the general multi-band antenna.

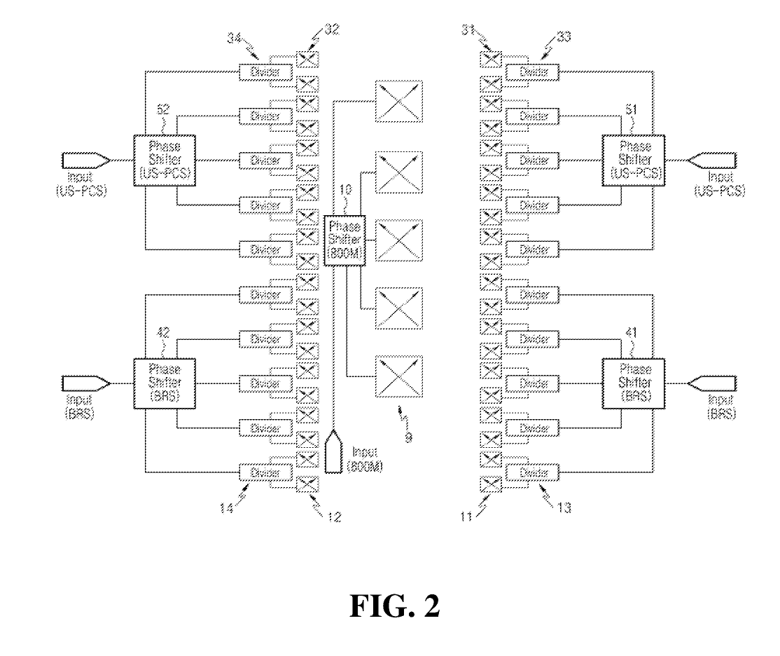

FIG. 3 illustrates a structure of a multi-band antenna according to an embodiment of the present disclosure.

FIG. 4 illustrates a structure of a multi-band antenna according to another embodiment of the present disclosure.

FIG. 5 illustrates a structure of a multi-band antenna according to a third embodiment of the present disclosure.

### DETAILED DESCRIPTION

Preferred embodiments of the present disclosure will be described below in detail with reference to the attached drawings. Specific details such as components are given to help comprehensive understanding of the present disclosure, and those skilled in the art will understand that various modifications or variations can be made to the specific details without departing from the scope and spirit of the present disclosure.

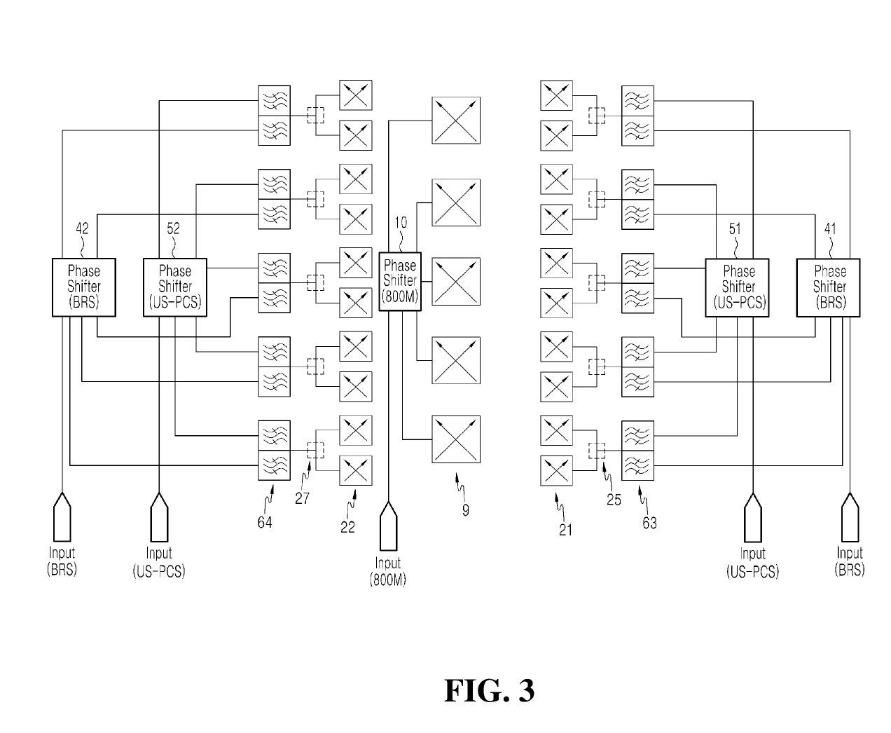

FIG. 3 is a diagram illustrating a structure of a multi-band antenna according to an embodiment of the present disclosure. For example, the multi-band antenna is a triple-band antenna. Referring to FIG. 3, the multi-band antenna according to the embodiment of the present disclosure may include, for example, the first antenna array 9 of the first band, and (2-1)^{th} and (2-2)^{th} antenna arrays 21 and 22 for second and third common bands, which are arranged on, for example, a single reflective plate (not shown) standing upright in a lengthwise direction.

The first antenna array 9 may be arranged at the center of the reflective plate, and the (2-1)^{th} and (2-2)^{th} antenna arrays 21 and 22 may be arranged on the left and right sides of the first antenna array 9, respectively. It may be understood that the (2-1)^{th} and (2-2)^{th} antenna arrays 21 and 22 are installed in a double structure to implement a MIMO antenna of the second and third bands in the above-described structure.

The first antenna array 9 is configured generally to include a plurality of radiation modules for the first band arranged vertically in a row. Similarly, each of the (2-1)^{th} and (2-2)^{th} antenna arrays 21 and 22 is configured generally to include a plurality of radiation modules for the second and third common bands arranged vertically in a row. That is, the radiation modules for the second and third common bands may be configured with broadband radiation elements covering both of the second and third bands.

To provide an electrical vertical tilt to total radiation beams emitted from the first antenna array 9 of the first band, the multi-band antenna includes the first phase shifter 10 for receiving an input signal of the first band, dividing the input signal, and providing the divided signals to the radiation modules of the first antenna array 9 in such a manner that the divided signals provided to the radiation modules arranged vertically in a row may have a predetermined phase difference between them.

To provide an electrical vertical tilt to radiation beams emitted from the (2-1)^{th} antenna array 21, the multi-band antenna further includes the (2-1)^{th} phase shifter 41 for receiving an input signal of the second band, dividing the input signal, and providing the divided signals to the radiation modules of the (2-1)^{th} antenna array 21, so that the radiation modules or groups of radiation modules may have a predetermined phase difference between them. The radiation modules of the (2-1)^{th} antenna array 21 may be grouped, for example, by pair, and each group of radiation modules may be connected to the (2-1)^{th} phase shifter 41 through one of a plurality of (2-1)'^{th} power dividers 25, provided on a group basis and one of a plurality of (2-1)^{th} frequency combiners 63, provided on a group basis. In this case, it may be noted that a phase difference is generated on a group basis.

The (2-1)^{th} power dividers 25 may be configured as general 2-way power dividers. Besides, the (2-1)^{th} power dividers 25 may be designed to be suitable for the characteristics of the second and third common bands.

Meanwhile, the multi-band antenna further includes the (3-1)^{th} phase shifter 51 for receiving an input signal of the third band, dividing the input signal, and providing the divided signals to the radiation modules of the (2-1)^{th} antenna array 21, so that the radiation modules or groups of radiation modules may have a predetermined phase difference between them.

One output terminal (combined terminal) of each of the plurality of (2-1)^{th} frequency combiners 63 is connected to one of the plurality of (2-1)^{th} power dividers 25, corresponding to the (2-1)^{th} frequency combiner 63. One of two input terminals of the (2-1)^{th} frequency combiner 63 is connected to the (2-1)^{th} phase shifter 41 and thus to a corresponding one of divided outputs of the (2-1)^{th} phase shifter 41, whereas the other input terminal of the (2-1)^{th} frequency combiner 63 is connected to a corresponding one of divided outputs of the (3-1)^{th} phase shifter 51. Each of the (2-1)^{th} frequency combiners 63 combines a signal output from the (2-1)^{th} phase shifter 41 with a signal output from the (3-1)^{th} phase shifter 51, and provides the combined signal to a (2-1)^{th} power divider 25 corresponding to the (2-1)^{th} frequency combiner 63.

Each (2-1)^{th} frequency combiner 63 may be a diplexer or duplexer having a filter for filtering the second band and a filter for filtering the third band in combination. While the term, frequency combiner has been used above, it will be understood that if the directions of input and output signals are reserved, this frequency combiner may have a configuration for serving as a frequency divider.

Likewise, the multi-band antenna further includes the (2-2)^{th} phase shifter 42 for receiving an input signal of the second band, dividing the input signal, and providing the divided signals to the radiation modules of the (2-2)^{th} antenna array 22, so that the radiation modules or groups of radiation modules may have a predetermined phase difference between them. Each group of radiation modules in the (2-2)^{th} antenna array 22 may be connected to the (2-2)^{th} phase shifter 42 through a corresponding one of a plurality of (2-2)^{th} power dividers 27 and a corresponding one of a plurality of (2-2)^{th} frequency combiners 64.

The multi-band antenna further includes the (3-2)^{th} phase shifter 52 for receiving an input signal of the third band, dividing the input signal, and providing the divided signals to the radiation modules of the (2-2)^{th} antenna array 22, so that the radiation modules or groups of radiation modules may have a predetermined phase difference between them.

In this case, each of the plurality of (2-2)^{th} frequency combiners 64 combines a corresponding one of signals output from the (2-2)^{th} phase shifter 42 with a corresponding a corresponding one of signals output from the (3-2)^{th} phase shifter 52, and provides the combined signal to the (2-2)^{th} power divider 27.

The structure of the multi-band antenna according to the embodiment of the present disclosure, illustrated in FIG. 3 enables the (2-1)^{th} and (2-2)^{th} antenna arrays 21 and 22 to commonly process wireless signals of the second and third bands using the (2-1)^{th} frequency combiners 63 and the (2-2)^{th} frequency combiners 64. Therefore, while the multi-band antenna still performs conventional functions, its total antenna size can be reduced.

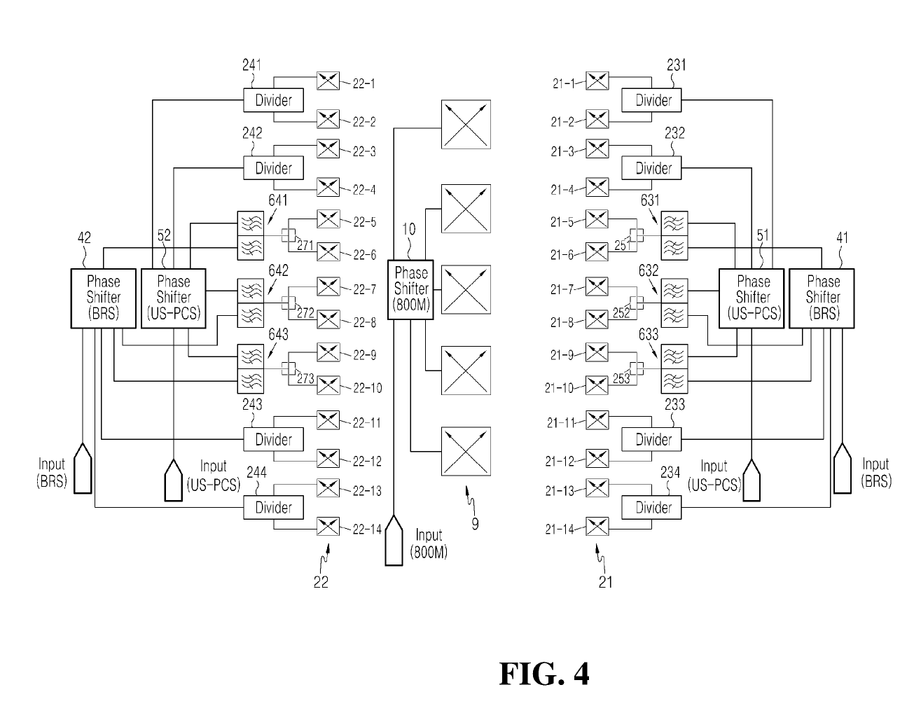

FIG. 4 is a diagram illustrating a structure of a multi-band antenna according to another embodiment of the present disclosure. Like the example of FIG. 3, the multi-band antenna is a triple-band antenna, by way of example. Referring to FIG. 4, the multi-band antenna according to the second embodiment of the present disclosure includes the first antenna array 9 of the first band, the first phase shifter 10, the (2-1)^{th} and (2-2)^{th} phase shifters 41 and 42, and the (3-1)^{th} and (3-2)^{th} phase shifters 51 and 52.

Similarly to the embodiment illustrated in FIG. 3, the (2-1)^{th} and (2-2)^{th} antenna arrays 21 and 22 of the second and third common bands are provided. The (2-1)^{th} and (2-2)^{th} antenna arrays 21 and 22 include radiation modules for the second and third common bands, 21-1, 21-2, . . . , 21-14, and 22-1, 22-2 . . . , 22-14, which are arranged vertically in a row. That is, the radiation modules for the second and third common bands, 21-1, 21-2, . . . , 21-14, and 22-1, 22-2 . . . , 22-14 include broadband radiation elements having broadband characteristics covering both of the second and third bands.

In the structure according to the second embodiment of the present invention, the radiation modules for the second and third common bands, 21-1, 21-2, . . . , 21-14, and 22-1, 22-2 . . . , 22-14 of the (2-1)^{th} and (2-2)^{th} antenna arrays 21 and 22 may be divided into three groups: a group for the second band, a group for the third band, and a group common for the second and third bands.

Among the radiation modules 21-1, 21-2, . . . , 21-14, of the (2-1)^{th} antenna array 21, in a sequential order, for example, the first to fourth radiation modules 21-1, 21-2, 21-3, and 21-4 are used for the third band, the 5^{th} to 10^{th} radiation modules 21-5, 21-6, 21-7, 21-8, 21-9, and 21-10 are used commonly for the second and third bands, and the 11^{th} to 14^{th} radiation modules 21-11, 21-12, 21-13, and 21-14 are used for the second band,.

That is, in the (2-1)^{th} antenna array 21, the first and second radiation modules 21-1 and 21-2 are connected to a corresponding one of outputs of the (3-1)^{th} phase shifter 51 through a (2-1-1)^{th} power divider 231, and the third and fourth radiation modules 21-3 and 21-4 are connected to a corresponding one of the outputs of the (3-1)^{th} phase shifter 51 through a (2-1-2)^{th} power divider 232. Also, in the (2-1)^{th} antenna array 21, the 11^{th} and 12^{th} radiation modules 21-11 and 21-12 are connected to a corresponding one of outputs of the (2-1)^{th} phase shifter 41 through a (2-1-3)^{th} power divider 233, and the 13^{th} and 14^{th} radiation modules 21-13 and 21-14 are connected to a corresponding one of the outputs of the (2-1)^{th} phase shifter 41 through a (2-1-4)^{th} power divider 234.

In the (2-1)^{th} antenna array 21, the 5^{th} and 6^{th} radiation modules 21-5 and 21-6 are connected to corresponding ones of the outputs of the (3-1)^{th} phase shifter 51 and the (2-1)^{th} phase shifter 41 through a (2-1-5)^{th} power divider 251 and a (2-1-1)^{th} frequency combiner 631, the 7^{th} and 8^{th} radiation modules 21-7 and 21-8 are connected to corresponding ones of the outputs of the (3-1)^{th} phase shifter 51 and the (2-1)^{th} phase shifter 41 through a (2-1-6)^{th} power divider 252 and a (2-1-2)^{th} frequency combiner 632, and the 9^{th} and 10^{th} radiation modules 21-9 and 21-10 are connected to corresponding ones of the outputs of the (3-1)^{th} phase shifter 51 and the (2-1)^{th} phase shifter 41 through a (2-1-7)^{th} power divider 253 and a (2-1-3)^{th} frequency combiner 633.

The (2-1-1)^{th} to (2-1-4)^{th} power dividers 231 to 234 may be designed suitably for characteristics of the second and third common bands, and the (2-1-5)^{th}, (2-1-6)^{th}, and (2-1-7)^{th} power dividers 251, 252, and 253 may be configured as general 2-way power dividers.

In the above structure, each of the (2-1-1)^{th}, (2-1-2)^{th}, and (2-1-3)^{th} frequency combiners 631, 632, and 633 is configured to combine a corresponding one of signals output from the (2-1)^{th} phase shifter 41 with a corresponding one of signals output from the (3-1)^{th} phase shifter 51 and provide the combined signal to a corresponding one of the (2-1-5)^{th}, (2-1-6)^{th} , and (2-1-7)^{th} power dividers 251, 252, and 253.

Meanwhile, the (2-2)^{th} antenna array 22 and its feeding network structure may be designed to be symmetrically same as the (2-1)^{th} antenna array 21 and its feeding network structure. That is, among the radiation modules 22-1, 22-2, . . . , 22-14, of the (2-2)^{th} antenna array 22, in a sequential order, for example, the first to fourth radiation modules 22-1, 22-2, 22-3, and 22-4 are used for the third band, the 5^{th} to 10^{th} radiation modules 22-5, 22-6, 22-7, 22-8, 22-9, and 22-10 are used commonly for the second and third bands, and the 11^{st} to 14^{th} radiation modules 22-11, 22-12, 22-13, and 22-14 are used for the second band.

Further, for the radiation modules 22-1, 22-2, . . . , 22-14 of the (2-2)^{th} antenna array 22 which are divided as described above, (2-2-1)^{th} to (2-2-7)^{th} power dividers 241 to 244, and (2-2-1)^{th}, (2-2-2)^{th}, and (2-2-3)^{th} frequency combiners 641, 642, and 643 are provided.

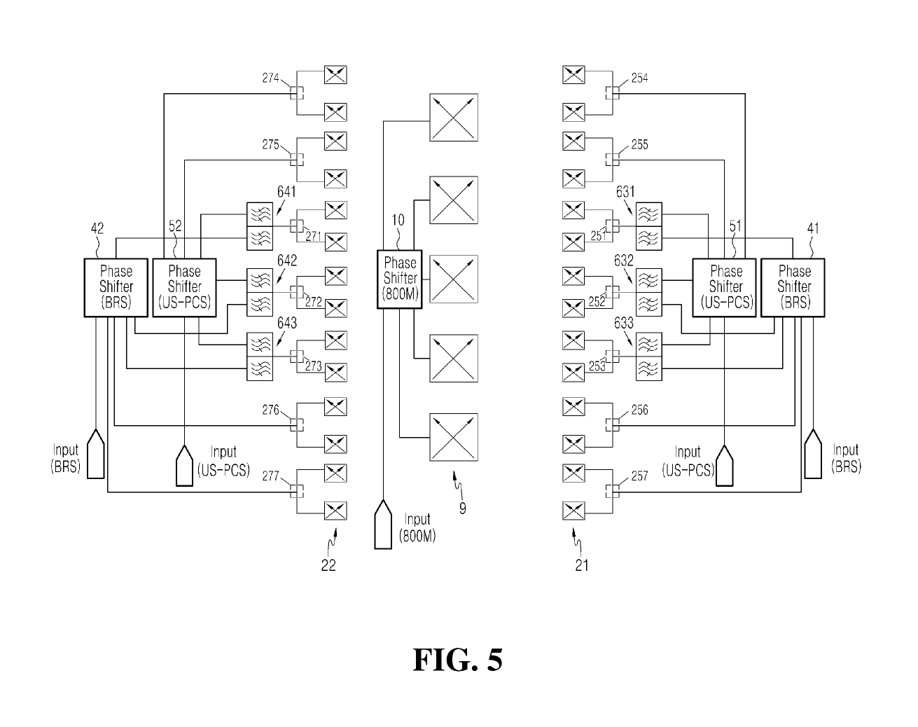

FIG. 5 is a diagram illustrating a structure of a multi-band antenna according to a third embodiment of the present disclosure. The structure according to the third embodiment of the present disclosure illustrated in FIG. 5 is almost same as the structure according to the second embodiment of the present disclosure illustrated in FIG. 4. However, the structures of FIGS. 4 and 5 differ in that while the (2-1-1)^{th} to (2-1-4)^{th} power combiners 231 to 234 and the (2-2-1)^{th} to (2-2-4)^{th} power combiners 241 to 244 are designed to be suitable for characteristics for the second and third common bands in FIGS. 4, (2-1-1)^{th} to (2-1-4)^{th} power combiners 254 to 257 and (2-2-1)^{th} to (2-2-4)^{th} power combiners 274 to 277 may be configured as general 2-way power dividers in FIG. 5.

The structures and operations of the multi-band antennas according to the foregoing embodiments of the present disclosure may be implemented as described above. While specific embodiments of the present disclosure have been described above, those skilled in the art will appreciate that the present disclosure may be carried out in other specific ways than those set forth herein without departing from the scope of the present disclosure.

For example, although it has been described above that a multi-band antenna of the present disclosure is provided with, for example, (2-1)^{th} and (2-2)^{th} antenna arrays in order to implement a MIMO antenna, the multi-band antenna may be configured to include, for example, only the (2-1)^{th} antenna array in other embodiments of the present disclosure.

Also, while it has been described above that the radiation modules of the (2-1)^{th} and (2-2)^{th} antenna arrays, for example, are divided into three groups: a group for the second band, a group common for the second and third groups, and a group for the third band, the radiation modules of the (2-1)^{th} and (2-2)^{th} antenna arrays may be divided into two groups: a group for the second band and a group common for the second and third groups in other embodiments of the present disclosure. Obviously, the radiation modules of the (2-1)^{th} and (2-2)^{th} antenna arrays may also be divided into two groups: a group common for the second and third groups and a group for the third band.

Therefore, the scope of the present disclosure should be determined by the appended claims and their legal equivalents, not by the above description, and all changes coming within the meaning and equivalency range of the appended claims are intended to be embraced therein. As described above, the multi-band antenna according to the present disclosure has an optimized structure and enables optimization of an antenna size, thereby facilitating antenna design and offering more stable characteristics.

What is claimed is:

1. A multi-band antenna comprising:
a first antenna array of a first band, including radiation modules for the first band;
a (2-1)^{th} antenna array of second and third common bands, including radiation modules for the second and third common bands;
a (2-1)^{th} phase shifter for receiving an input signal of the second band, dividing the input signal, and providing divided signals having a phase difference to predetermined radiation modules or a plurality of radiation module groups on a radiation module basis or a radiation module group basis among the radiation modules of the (2-1)^{th} antenna array;
a (3-1)^{th} phase shifter for receiving an input signal of the third band, dividing the input signal, and providing divided signals having a phase difference to predetermined radiation modules or a plurality of radiation module groups on a radiation module basis or a radiation module group basis among the radiation modules of the (2-1)^{th} antenna array; and
a plurality of (2-1)^{th} frequency combiners each for combining a predetermined one of signals output from the (2-1)^{th} phase shifter with one of signals output from the (3-1)^{th} phase shifter corresponding to the (2-1)^{th} frequency combiner, and providing the combined signal to each of predetermined radiation modules or a predetermined one of a plurality of radiation module groups among the radiation modules of the (2-1)^{th} antenna array.

2. The multi-band antenna of claim 1, further comprising:
a (2-2)^{th} antenna array of the second and third common bands, including radiation modules for the second and third common bands;
a (2-2)^{th} phase shifter for receiving an input signal of the second band, dividing the input signal, and providing divided signals having a phase difference to predetermined radiation modules or a plurality of radiation module groups on a radiation module basis or a radiation module group basis among the radiation modules of the (2-2)^{th} antenna array;
a (3-2)^{th} phase shifter for receiving an input signal of the third band, dividing the input signal, and providing divided signals having a phase difference to predetermined radiation modules or a plurality of radiation module groups on a radiation module basis or a radiation module group basis among the radiation modules of the (2-2)^{th} antenna array; and
a plurality of (2-2)^{th} frequency combiners each for combining a predetermined one of signals output from the (2-2)^{th} phase shifter with one of signals output from the (3-2)^{th} phase shifter corresponding to the (2-2)^{th} frequency combiner, and providing the combined signal to each of predetermined radiation modules or a predetermined one of a plurality of radiation module groups among the radiation modules of the (2-2)^{th} antenna array.

3. The multi-band antenna of claim 2, wherein the first antenna array is disposed at the center of a reflective plate, and the (2-1)^{th} antenna array and (2-2)^{th} antenna array are disposed respectively on the left and right sides of the first antenna array.

4. The multi-band antenna of claim 2, wherein the radiation modules of each of the (2-1)^{th} antenna array and (2-2)^{th} antenna array are grouped into the plurality of radiation module groups each having a pair of radiation modules.

5. The multi-band antenna of claim 4, wherein the power dividers are configured using broadband 2-way power dividers or dividers having characteristics designed for the second and third common bands.

6. The multi-band antenna of claim 1, wherein the radiation modules of the (2-1)^{th} antenna array are divided into a group used for the second or third band, a group for the third band, and a group common for the second and third bands, the group for the second or third band is connected to one of the (2-1)^{th} phase shifter and the (3-1)^{th} phase shifter, corresponding to the group for the second or third band, and the group common for the second and third bands is connected to the (2-1)^{th} phase shifter and the (3-1)^{th} phase shifter, through the (2-1)^{th} frequency combiners.

7. The multi-band antenna of claim 2, wherein the radiation modules of the (2-1)^{th} antenna array are divided into a group used for the second or third band, a group for the third band, and a group common for the second and third bands, the group for the second or third band among the radiation modules of the (2-1)^{th} antenna array is connected to one of the (2-1)^{th} phase shifter and the (3-1)^{th} phase shifter, corresponding to the group for the second or third band, and the group common for the second and third bands among the radiation modules of the (2-1)^{th} antenna array is connected to the (2-1)^{th} phase shifter and the (3-1)^{th} phase shifter, through the (2-1)^{th} frequency combiners, the radiation modules of the (2-2)^{th} antenna array are divided into a group used for the second or third band, a group for the third band, and a group common for the second and third bands, the group for the second or third band among the radiation modules of the (2-2)^{th} antenna array is connected to one of the (2-1)^{th} phase shifter and the (3-1)^{th} phase shifter, corresponding to the group for the second or third band, and the group common for the second and third bands among the radiation modules of the (2-2)^{th} antenna array is connected to the (2-1)^{th} phase shifter and the (3-1)^{th} phase shifter, through the (2-1)^{th} frequency combiners.
